(19) United States
(12) Patent Application Publication
(10) Pub. No.: US 2023/0353530 A1
(43) Pub. Date: Nov. 2, 2023

(54) SYSTEMS AND METHODS FOR GENERATING AUTOMATICALLY SUGGESTED RECOMMENDATIONS BASED ON AGGREGATED RECOMMENDATIONS WITHIN A SOCIAL NETWORKING SYSTEM

(71) Applicant: Meta Platforms, Inc., Menlo Park, CA (US)

(72) Inventors: Matthew Logan Schmid, New York, NY (US); Kejun Chu, Jersey City, NJ (US); Liwen Lin, New York, NY (US)

(21) Appl. No.: 16/127,160

(22) Filed: Sep. 10, 2018

(51) Int. Cl. H04L 12/58; G06Q 50/00; G06F 17/27; G06F 17/30

(52) U.S. Cl. CPC H04L 51/32; H04L 51/20; G06Q 50/01; G06F 17/2765; G06F 17/30867

(57) ABSTRACT

Systems, methods, and non-transitory computer readable media can aggregate recommendations from users within a social networking system. A table including a plurality of entity-user pairs can be generated based on the aggregated recommendations, wherein each entity-user pair of the plurality of entity-user pairs is based on an entity and a user having one or more connections within the social networking system that have provided recommendations relating to the entity. A request from a particular user to access a recommendation request can be received. One or more automatically suggested recommendations can be generated for the particular user in connection with the recommendation request based on the table.

### FIELD OF THE INVENTION

The present technology relates to the field of social networks. More particularly, the present technology relates to techniques for generating recommendations associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system may provide resources through which users may publish content items. In one example, a content item can be presented on a profile page of a user. As another example, a content item can be presented through a feed for a user to access.

### SUMMARY

Various embodiments of the present technology can include systems, methods, and non-transitory computer readable media configured to aggregate recommendations from users within a social networking system. A table including a plurality of entity-user pairs can be generated based on the aggregated recommendations, wherein each entity-user pair of the plurality of entity-user pairs is based on an entity and a user having one or more connections within the social networking system that have provided recommendations relating to the entity. A request from a particular user to access a recommendation request can be received. One or more automatically suggested recommendations can be generated for the particular user in connection with the recommendation request based on the table.

In some embodiments, the recommendation request includes a type of entity and a geographical area for which a recommendation is requested.

In certain embodiments, the recommendations by the one or more connections of the user in each entity-user pair are accessible to the user based on privacy settings associated with the recommendations.

In an embodiment, the table is generated offline.

In some embodiments, the generating the one or more automatically suggested recommendations includes searching the table to determine one or more candidate entities based on one or more entity-user pairs of the plurality of entity-user pairs for the particular user.

In certain embodiments, the generating the one or more automatically suggested recommendations includes checking privacy settings associated with recommendations by one or more connections of the particular user in the one or more entity-user pairs of the plurality of entity-user pairs for the particular user to determine whether the recommendations are accessible to the particular user.

In an embodiment, the generating the one or more automatically suggested recommendations includes ranking the one or more candidate entities.

In some embodiments, the generating the one or more automatically suggested recommendations includes ranking at least one or more of: one or more candidate entities from users who are associated with a geographical area in the recommendation request or one or more top candidate entities associated with a type of entity in the recommendation request.

In certain embodiments, it can be determined that natural language content includes the recommendation request based on natural language processing.

In an embodiment, the recommendation request is generated in a feed of a user, a group in the social networking system, or a page in the social networking system.

In some embodiments, a response to the recommendation request including natural language content can be obtained.

In certain embodiments, it can be determined that the response includes a recommendation based on natural language processing.

In an embodiment, a type of entity associated with the recommendation can be determined.

In some embodiments, the one or more automatically suggested recommendations can be updated based on the type of entity associated with the recommendation.

In certain embodiments, the request from the particular user to access the recommendation request is generated in a feed of the particular user, a group in the social networking system, or a page in the social networking system.

In an embodiment, one or more direct recommendations for the recommendation request can be obtained.

In some embodiments, the one or more automatically suggested recommendations are generated after a threshold number of direct recommendations is obtained.

In certain embodiments, the one or more automatically suggested recommendations are presented as respective cards in a user interface.

It should be appreciated that many other features, applications, embodiments, and/or variations of the present technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system including an example recommendation module configured to generate automated recommendations, according to an embodiment of the present technology.

FIG. 2A illustrates an example recommendation aggregation module configured to aggregate recommendations, according to an embodiment of the present technology.

FIG. 2B illustrates an example automated recommendation generation module configured to generate automated recommendations based on aggregated recommendations, according to an embodiment of the present technology.

FIG. 3A illustrates an example user interface for generating automated recommendations, according to an embodiment of the present technology.

FIG. 3B illustrates an example user interface for generating automated recommendations, according to an embodiment of the present technology.

FIG. 4 illustrates an example first method for generating automated recommendations, according to an embodiment of the present technology.

FIG. 5 illustrates an example second method for generating automated recommendations, according to an embodiment of the present technology.

FIG. 6 illustrates a network diagram of an example system that can be utilized in various scenarios, according to an embodiment of the present technology.

FIG. 7 illustrates an example of a computer system that can be utilized in various scenarios, according to an embodiment of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

Generating Automatically Suggested Recommendations Based on Aggregated Recommendations within a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In one example, a content item can be presented on a profile page of a user. As another example, a content item can be presented through a feed for a user to access.

Under conventional approaches specifically arising in the realm of computer technology, a user can create a post within a social networking system requesting recommendations. For example, the user may request recommendations for a place, such as a restaurant. Another user may then respond to the post with a recommendation, for example, by creating a comment to the response. However, in some cases, the user may not receive a sufficient number of recommendations from other users, and the user may not obtain needed information.

An improved approach rooted in computer technology can overcome the foregoing and other disadvantages associated with conventional approaches specifically arising in the realm of computer technology. Based on computer technology, the present technology can generate automatically suggested recommendations. For example, automatically suggested recommendations can be generated for requests for recommendations (“recommendation requests”) based on aggregated recommendations from various sources. A user may create a recommendation request by creating a post requesting recommendations, entering a query in a search box looking for recommendations, etc. Automatically suggested recommendations may supplement recommendations provided by users in direct response to a request for recommendation, for example, in comments to a post requesting recommendations. The present technology can aggregate recommendations from various sources based on one or more social graphs representing users, entities, and recommendations. For example, a table including entity-user pairs can be created. For each entity, an entity-user pair can be created for each user that has at least one connection who has previously recommended the entity. Automatically suggested recommendations can be generated for recommendation requests based on the aggregated recommendations. In some embodiments, the present technology can determine whether a content item, such as a post, created by a user includes a recommendation request based on natural language processing. Similarly, the present technology can determine whether a response to a content item, such as a comment in response to a post, includes a recommendation based on natural language processing. An automatically suggested recommendation for a user can be generated with respect to an entity based on previous recommendations by the user's connections for that entity from the aggregated recommendations. Privacy settings associated with the previous recommendations can be checked to determine whether the previous recommendations are accessible to the user based on a privacy model. An automatically suggested recommendation can also be generated based on recommendations by users in a geographical area relating to a recommendation request, top recommended entities, etc. In this way, the present technology can provide automatically suggested recommendations for recommendation requests by users in a privacy aware manner. Additional details relating to the present technology are provided below.

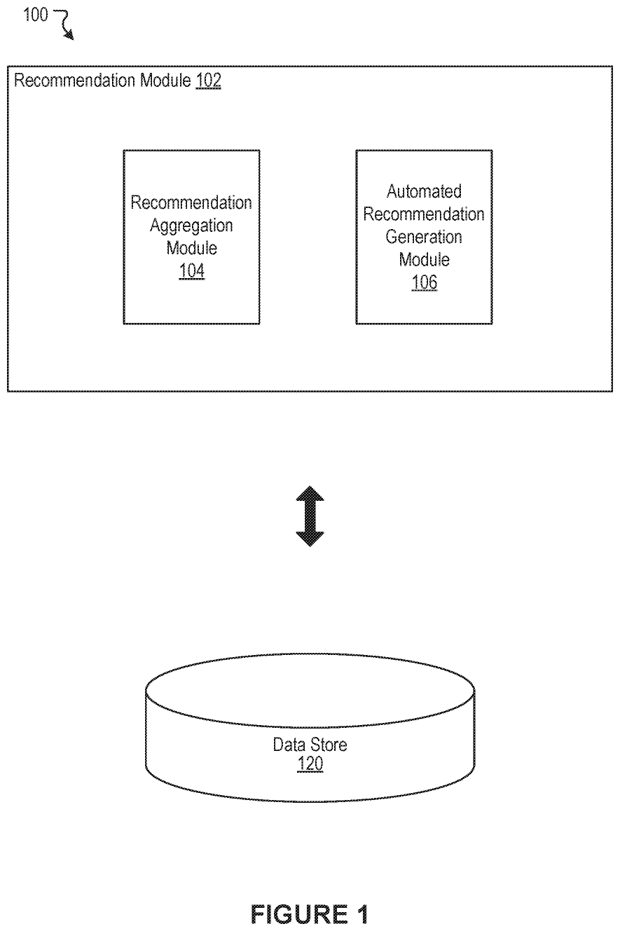

FIG. 1 illustrates an example system 100 including an example recommendation module 102 configured to generate automated recommendations, according to an embodiment of the present technology. The recommendation module 102 can include a recommendation aggregation module 104 and an automated recommendation generation module 106. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the recommendation module 102 can be implemented in any suitable combinations. While the present technology is described in connection with recommendations associated with a social networking system for illustrative purposes, the present technology can apply to any other type of system and/or content.

The recommendation aggregation module 104 can aggregate recommendations from various sources. For example, the recommendation aggregation module 104 can aggregate recommendations from various sources within a social networking system and generate an aggregated table. An aggregated table of recommendations can be generated based on one or more social graphs. The recommendation aggregation module 104 can check privacy settings associated with recommendations to determine which recommendations are accessible to particular users. Functionality of the recommendation aggregation module 104 is described in more detail herein.

The automated recommendation generation module 106 can generate automated recommendations based on aggregated recommendations. For example, the automated recommendation generation module 106 generate automatically suggested recommendations for a recommendation request based on various sources, including an aggregated table of recommendations. Functionality of the automated recommendation generation module 106 is described in more detail herein.

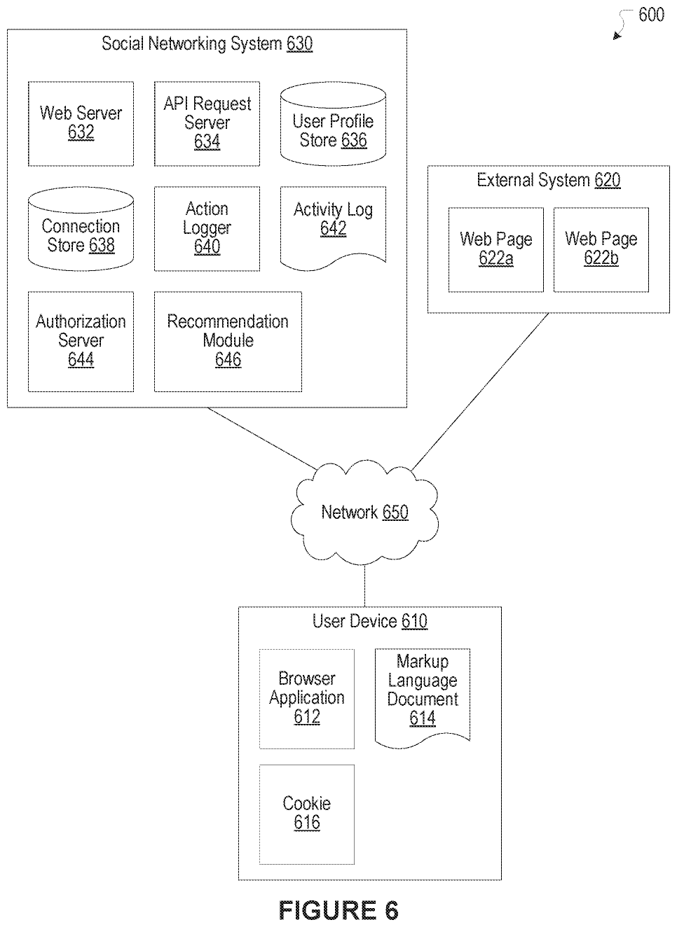

In some embodiments, the recommendation module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the recommendation module 102 can be, in part or in whole, implemented as software running on one or more computing devices or systems, such as on a server system or a client computing device. In some instances, the recommendation module 102 can be, in part or in whole, implemented within or configured to operate in conjunction or be integrated with a social networking system (or service), such as a social networking system 630 of FIG. 6. Likewise, in some instances, the recommendation module 102 can be, in part or in whole, implemented within or configured to operate in conjunction or be integrated with a client computing device, such as the user device 610 of FIG. 6. For example, the recommendation module 102 can be implemented as or within a dedicated application (e.g., app), a program, or an applet running on a user computing device or client computing system. The application incorporating or implementing instructions for performing functionality of the recommendation module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The data store 120 can be configured to store and maintain various types of data, such as the data relating to support of and operation of the recommendation module 102. The data maintained by the data store 120 can include, for example, information relating to recommendations, aggregated recommendations, automatically suggested recommendations, content items, posts, comments, social graphs, privacy settings, natural language processing, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the recommendation module 102 can be configured to communicate and/or operate with the data store 120. In some embodiments, the data store 120 can be a data store within a client computing device. In some embodiments, the data store 120 can be a data store of a server system in communication with the client computing device.

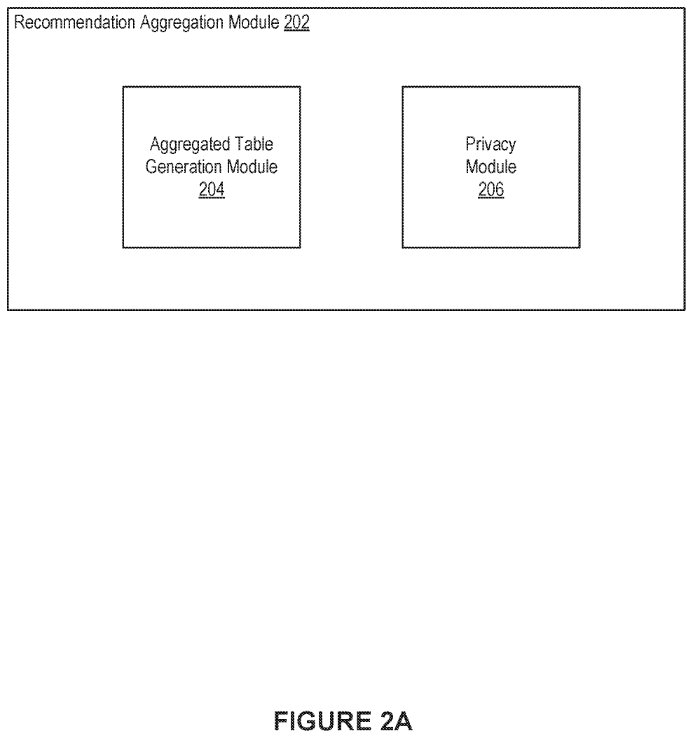

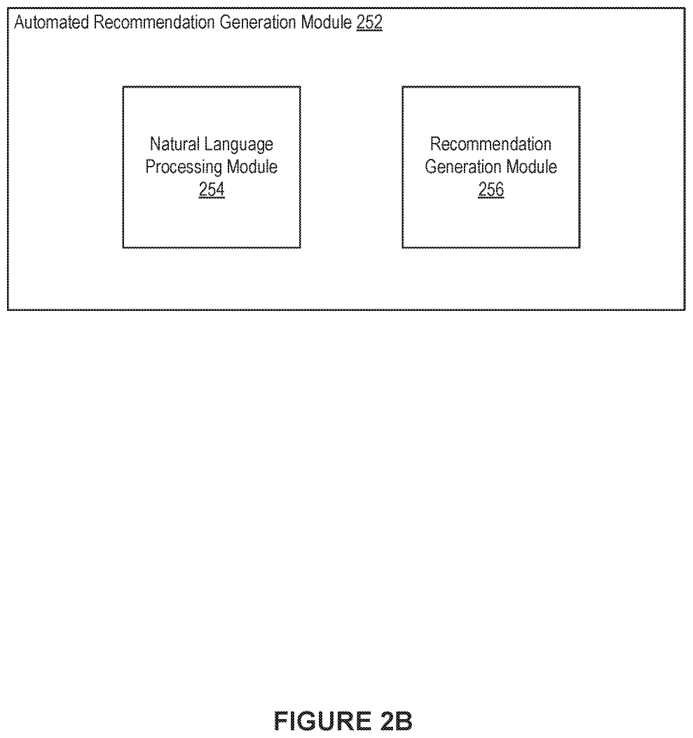

FIG. 2A illustrates an example recommendation aggregation module 202 configured to aggregate recommendations, according to an embodiment of the present technology. In some embodiments, the recommendation aggregation module 104 of FIG. 1 can be implemented with the example recommendation aggregation module 202. As shown in the example of FIG. 2A, the example recommendation aggregation module 202 can include an aggregated table generation module 204 and a privacy module 206.

The aggregated table generation module 204 can aggregate recommendations from various sources within a social networking system and generate an aggregated table. For example, the aggregated table generation module 204 can aggregate recommendations that have been previously created within the social networking system. A user may create a recommendation in various contexts and/or various surfaces within a social networking system. For example, a user may respond with a recommendation to a recommendation request in a feed of the user. As another example, a user may provide a recommendation in a group. As an additional example, a user may provide a recommendation on a page representing an entity. Many variations are possible. A recommendation may be included in a content item, such as a post. A recommendation can relate to an entity, such as a business. Each recommendation can have an associated privacy setting. For example, a privacy setting can indicate an audience of one or more users to whom a recommendation or a content item including the recommendation is accessible.

The aggregated table generation module 204 can generate an aggregated table based on one or more social graphs. Recommendations, users who created recommendations, and entities to which recommendations relate can be reflected in a social graph. A social graph can represent various types of objects as nodes and can reflect relationships, interactions, affinities, etc. among the objects based on one or more edges between nodes. For example, a social graph can represent recommendations, users who created recommendations, and entities to which recommendations relate as nodes and represent relationships between the recommendations, the users who created recommendations, and the entities to which recommendations relate as one or more edges between the nodes. As discussed herein, a user who creates a recommendation can be referred to as a “recommending user.” An entity to which a recommendation relates can be referred to as a “recommendation entity.” Examples of entities can include businesses, companies, locations, places, etc. Recommending users may be connections of other users within the social networking system. The other users may also be represented as nodes in the social graph, and relationships between the recommending users and the other users can also be represented as one or more edges between the nodes. A content item and a response to a content item can also be represented as nodes in the social graph, and a relationship between the content item and the response can be represented as one or more edges between the nodes. For example, the content item can be a post, and the response to the content item can be a comment in response to the post.

An aggregated table of recommendations can be generated based on one or more social graphs. In some embodiments, the aggregated table can include recommendations for entity-user pairs. For example, an entity-user pair can be created for an entity and each user that has at least one connection within a social networking system that has recommended the entity. An entity-user pair can indicate an entity and a user, and be associated with one or more connections of the user who have recommended the entity. The entity-user pair can also be associated with one or more recommendations relating to the entity from the one or more connections of the user. The entity-user pair may only be associated with recommendations that are accessible to the user based on respective privacy settings associated with the recommendations. For example, privacy settings associated with the recommendations can be determined by the privacy module 206, as described below. An entity-user pair can be stored as a row in the aggregated table. Entity-user pairs can be created based on some or all entities represented in a social networking system and some or all users associated with the social networking system.

The aggregated table generation module 204 can generate an aggregated table in an offline or non-real time manner. A social networking system may have a significant number of users, recommendations, and entities, and accordingly, an aggregated table can include a significant amount of data. The aggregated table generation module 204 can generate the aggregated table in an offline manner in order to increase performance and efficiency. The aggregated table generation module 204 can periodically generate and/or update the aggregated table. The aggregated table can be stored in one or more databases. In some embodiments, the aggregated table generation module 204 can create an index for the aggregated table.

The privacy module 206 can check privacy settings associated with recommendations to determine which recommendations are accessible to particular users. As described above, a recommendation can be created by a user in various contexts and/or on various surfaces. Each recommendation or a content item in which the recommendation is included can have associated privacy settings that indicate an audience to which the recommendation or the content item is accessible. For example, privacy settings associated with a recommendation or a content item can specify that the recommendation or the content item is accessible to only a user who created the or the content item, accessible to only a subset of connections of the user, accessible to only connections of the user, accessible to only connections of connections of the user, accessible to some other designated audience, or accessible to all users. Privacy settings associated with recommendations or content items may be specified based on one or more privacy models. The recommendation or the content item including the recommendation can be accessible to users who have permission to access the recommendation or the content item based on the associated privacy settings. As an example, a user can create a recommendation in response to a recommendation request in a content item, such as a post requesting recommendations. For instance, a content item including a recommendation request may be included in a feed of the user. The user can provide a recommendation in a comment in response to the content item. The recommendation in the comment can be accessible to users who have permission to access the content item based on privacy settings associated with the content item. As another example, a user can create a recommendation in a group. For instance, a user can create a content item, such as a post, that includes a recommendation in a group. A group can include one or more users and can be open or closed. If the group is an open group, the recommendation or the content item including the recommendation can be accessible to users who are members of the group as well as users who are not members of the group. If the group is a closed group, the recommendation or the content item including the recommendation can be accessible to only users who are members of the group. As a further example, a user can create a recommendation on a page. A page can be associated with an entity and indicate presence of the entity in a social networking system. For instance, the user can create a content item, such as a post, that includes a recommendation on the page. The recommendation or the content item including the recommendation can be accessible to users based on privacy settings associated with the recommendation or the content item.

The privacy module 206 can check privacy settings associated with recommendations or content items including recommendations in order to generate the aggregated table. For example, the privacy module 206 can check privacy settings associated with recommendations or content items to determine which recommendations or content items should be included in the aggregated table for a particular entity-user pair. As described above, an entity-user pair can indicate an entity and a user. The entity-user pair can be associated with one or more connections of the user who have recommended the entity and/or recommendations from the one or more connections of the user who have recommended the entity. In some embodiments, the aggregated table can include only the connections of the user that have provided recommendations that are accessible to the user based on privacy settings associated with the recommendations and corresponding recommendations that are accessible to the user.

The privacy module 206 can also check privacy settings associated with recommendations or content items including recommendations in order to generate automatically suggested recommendations. For example, the aggregated table can be queried in real time in order to generate automatically suggested recommendations, as described below in connection with the automated recommendation generation module 252. If a recommendation request is created, accessed, or viewed by a particular user, such as a post including a recommendation request, the aggregated table can be queried for entity-user pairs for the particular user in order to generate one or more automatically suggested recommendations. Although the aggregated table may only include recommendations which are accessible to the particular user, privacy settings associated with the recommendations may have changed between the time at which the aggregated table was generated or updated and the time at which the automatically suggested recommendations are generated for the particular user. For example, a privacy setting associated with a recommendation at an earlier time may be less restrictive than a privacy setting associated with the recommendation at a later time when automatically suggested recommendations are generated. Accordingly, the privacy module 206 can check the privacy settings associated with the recommendations when generating the automatically suggested recommendations to determine whether the recommendations are still accessible to the particular user based on current privacy settings associated with the recommendations. All examples herein are provided for illustrative purposes, and there can be many variations and other possibilities.

FIG. 2B illustrates an example automated recommendation generation module 252 configured to generate automated recommendations based on aggregated recommendations, according to an embodiment of the present technology. In some embodiments, the automated recommendation generation module 106 of FIG. 1 can be implemented with the example automated recommendation generation module 252. As shown in the example of FIG. 2B, the example automated recommendation generation module 252 can include a natural language processing module 254 and a recommendation generation module 256.

The automated recommendation module 252 can generate automatically suggested recommendations for recommendation requests. A user can create a recommendation request in various contexts and/or on various surfaces. As an example, a user can create a content item including a recommendation request. For instance, the content item can be a post. As another example, a user can enter a query including a recommendation request in a search box. As an additional example, a user can send a communication including a recommendation request to a bot or an automated agent of an application, such as a messaging application. As mentioned above, a user can also create a recommendation in various contexts and/or through various surfaces. As an example, a user may provide a recommendation in response to a content item including a recommendation request. For instance, the content item can be a post, and the user may provide a recommendation in a comment in response to the post. As another example, a user may create a content item including a recommendation in a group. For instance, the content item can be a post. As an additional example, a user may create a content item including a recommendation on a page representing an entity. For instance, the content item can be a post. Many variations are possible.

The natural language processing module 254 can analyze natural language content or a natural language query in order to determine whether the natural language content or query includes a recommendation request. The natural language processing module 254 can analyze the natural language content based on natural language processing (NLP) or natural language understanding (NLU). The natural language content can include text entered by a user, text generated based on speech recognition techniques, etc. In some cases, a user may create a recommendation request by creating a content item. For example, the content item can be a post, and the user can enter text requesting recommendations for the post. A recommendation request can include a particular type or category of entity, such as restaurants, and a particular geographical area, such as a city. Examples of types of entities can include or relate to businesses, companies, locations, places, etc. Examples of geographical areas can include a neighborhood, a district, a city, a county, a state, a country, etc. The natural language processing module 254 can analyze the natural language content in order to determine an intent associated with the natural language content. For example, the intent associated with the natural language content can be to request recommendations. The intent may also be associated with a particular type of entity. If the intent associated with the natural language content is to request recommendations, the natural language processing module 254 can determine that the natural language content includes a recommendation request. The natural language processing module 254 can determine that the natural language content includes a recommendation request if an associated confidence level relating to the existence of a recommendation request satisfies a threshold value. If the intent associated with the natural language content is to request recommendations, the natural language processing module 254 can also analyze the natural language content in order to determine a geographical area for which recommendations are requested. The natural language processing module 254 can train one or more natural language processing models to determine whether an intent associated with natural language content is to request recommendations and to determine a geographical area for which recommendations are requested. In some embodiments, a first natural language processing model can be trained to determine whether a user is requesting recommendations and whether the user is requesting recommendations for a particular type of entity, and a second natural language processing model can be trained to determine an area for which the user is requesting recommendations. In certain embodiments, the first natural language processing model can be an intent model, and the second natural language processing model can be a slot model. An intent model may be based on a type of entity. The second natural language processing model can perform slot detection. An extracted slot from the slot detection can be run through a search algorithm to identify the area. In this way, automatically suggested recommendations can be provided for a recommendation request that includes required information, such as a type of entity and a geographical area. Many variations are possible.

The natural language processing module 254 can also analyze natural language content or a natural language query in order to determine whether the natural language content or query includes a recommendation. The natural language processing module 254 can analyze the natural language content based on natural language processing or natural language understanding. The natural language content can include text entered by a user, text generated based on speech recognition techniques, etc. In some cases, a user may create a recommendation by responding to a content item including a recommendation request. For example, the content item can be a post, and the user may create a comment in response to the post. The user can enter text providing a recommendation for the recommendation request for the comment. A recommendation can be for a particular type or category of entity and a particular geographical area that is specified in a recommendation request. The natural language processing module 254 can analyze the natural language content in order to determine an intent associated with the natural language content. For example, an intent associated with the natural language content can be to provide a recommendation. The intent may also be associated with a particular type of entity. If the intent associated with the natural language content is to provide a recommendation, the natural language processing module 254 can determine that the natural language content includes a recommendation. The natural language processing module 254 can determine that the natural language content includes a recommendation if an associated confidence level relating to the existence of a recommendation satisfies a threshold value. If the intent associated with the natural language content is to provide a recommendation, the natural language processing module 254 can also analyze the natural language content in order to determine a particular entity that is being recommended. The natural language processing module 254 can train one or more natural language processing models to determine whether an intent associated with natural language content is to provide a recommendation and to determine a particular entity being recommended. In some embodiments, a first natural language processing model can be trained to determine whether a user is providing a recommendation, and a second natural language processing model can be trained to determine an entity associated with the recommendation. In certain embodiments, the first natural language processing model can be an intent model, and the second natural language processing model can be a slot model. An intent model may be based on a type of entity. For example, the second natural language processing model can perform slot detection. An extracted slot from the slot detection can be run through a search algorithm to identify the entity. For example, the search algorithm can be a search for entities associated with a particular geographical area. A recommendation as determined in this manner can be represented as a node in a social graph, as described above. Many variations are possible.

The recommendation generation module 256 can generate automatically suggested recommendations for a recommendation request. For example, the recommendation generation module 256 can generate automatically suggested recommendations in or near real time. In some cases, whether a recommendation request is created can be determined by the natural language processing module 254, as described above. A recommendation request can be accessed by different users. For example, the recommendation request can be accessed by a user who created the recommendation request as well as one or more other users. The recommendation generation module 256 can generate automatically suggested recommendations for the recommendation request based on a particular user who is accessing the recommendation request, and accordingly, the automatically suggested recommendations can be personalized for the particular user. As discussed herein, a user who is accessing a recommendation request can be referred to as a “viewing user.”

The recommendation generation module 256 can generate automatically suggested recommendations based on various sources. For example, the recommendation generation module 256 can identify one or more candidate entities for generating automatically suggested recommendations from various sources. For example, sources of recommendations for generating automatically suggested recommendations can include an aggregated table for recommendations. The aggregated table can be generated by the recommendation aggregation module 202, as described above. The recommendation generation module 256 can query or search the aggregated table for recommendations in order to identify entities that have one or more recommendations by connections of a viewing user and relate to the recommendation request. For example, the search can identify entities that have one or more recommendations by connections of the viewing user and that satisfy a type of entity and a geographical area specified in the recommendation request as candidate entities. Since privacy settings associated with recommendations relating to candidate entities may have changed since the time the aggregated table was generated, the recommendation generation module 256 can check the privacy settings associated with the recommendations when generating automatically suggested recommendations to make sure that the recommendations are still accessible to the viewing user. For example, the privacy settings can be checked by the recommendation aggregation module 202, as described above.

The recommendation generation module 256 can also generate automatically suggested recommendations based on sources of recommendations other than the aggregated table. For example, sources of recommendations for generating automatically suggested recommendations can include recommendations created by users who are local to a geographic area specified in a recommendation request, recommendations for top recommended entities for a particular type of entity, recommendations for top recommended entities for a particular category, etc. Users who are local to a geographical area may include users who primarily reside or work in the geographical area or are otherwise associated with the geographical area. A particular category may be a category associated with a page of an entity within a social networking system. Examples of types of entities and examples of categories can include restaurants, cafes, stores, services, etc. In some embodiments, a type of entity and a category associated with a page of an entity can be the same. In other embodiments, a type of entity and a category associated with a page of an entity can be different. The recommendation generation module 256 can identify candidate entities for generating automatically suggested recommendations from recommendations from sources other than the aggregated table. For example, entities that satisfy a type of entity and a geographical area specified in a recommendation request can be identified as candidate entities. Privacy settings associated with recommendations relating to the candidate entities can be checked to make sure that the recommendations are accessible to a viewing user, for example, by the recommendation aggregation module 202.

The recommendation generation module 256 can rank one or more candidate entities for a recommendation request from various sources of recommendations. The recommendation generation module 256 can rank one or more candidate entities for the recommendation request based on various factors. In some embodiments, the recommendation generation module 256 can generate a score for each automatically suggested recommendation that can be used to perform the ranking. In some embodiments, the recommendation generation module 256 can rank one or more candidate entities based on a source of recommendations. In some embodiments, candidate entities that have been recommended by connections of a viewing user can be ranked higher than candidate entities that have been recommended by users who are not connections of the viewing user. For example, candidate entities that have been recommended by connections of the viewing user can be ranked higher than candidate entities from recommendations by users who are local to the geographic area in the recommendation request and/or candidate entities from top recommendations for a particular type of entity or a particular category. In addition, candidate entities from recommendations by users who are local to the geographic area in the recommendation request can be ranked higher than candidate entities from top recommendations for a particular type of entity or a particular category, and vice versa. Many variations are possible.

The recommendation generation module 256 can generate one or more automatically suggested recommendations for a recommendation request based on ranked candidate entities. In some embodiments, the recommendation generation module 256 can generate automatically suggested recommendations for a predetermined number of top ranked candidate entities. In other embodiments, the recommendation generation module 256 can generate automatically suggested recommendations for a predetermined number of top ranked candidate entities from each source of recommendations. Many variations are possible. An automatically suggested recommendation can relate to a particular entity and can include information relating to the particular entity, users who have recommended the particular entity, a source of recommendations on which the automatically suggested recommendation is based, etc. In some embodiments, the recommendation generation module 256 can customize or personalize automatically suggested recommendations based on information associated with a viewing user, such as historical activities of the viewing user within the social networking system. For example, if the viewing user has checked in to entities of a particular type, more automatically suggested recommendations can be provided for that particular type. In some embodiments, an entity to which an automatically suggested recommendation relates can be associated with a location, and the automatically suggested recommendation can be presented on a map. For example, the automatically suggested recommendation can be presented as a card on the map, and an indicator, such as a pin, for the location associated with the entity can be provided on the map. If multiple automatically suggested recommendations are provided, a viewing user may scroll or swipe between cards for the multiple automatically suggested recommendations. An indicator associated with a card for a selected automatically suggested recommendation can be shown as selected or highlighted. In some embodiments, after provision of a recommendation request by a user but before comments are provided by other users in response to the recommendation request, a map displayed to the user can be prepopulated with automatically suggested recommendations that are displayed on the map as pins. After another user provides a comment as a recommendation in response to the recommendation request, the displayed map can be updated by display of a pin corresponding to the comment. Pins corresponding to comments provided as recommendations can be displayed on a map so that the pins are distinct (e.g., visually distinct) from pins corresponding to other types of recommendations. Distinctions among different types of recommendations can be displayed through corresponding pins that have, for example, different sizes (e.g., larger versus smaller), different colors, and other contrasting attributes. In some embodiments, a recommendation in response to a recommendation request associated with a map can include one or more recommendations from a user who has provided recommendations in the past. An analysis can be performed on the recommendation request, as described above, to determine, for example, an associated type of entity and geographical area. It can be determined whether the user previously provided relevant recommendations that would match the recommendation request. If so, as the user prepares a response to the recommendation request, such previous relevant recommendations of the user can be automatically presented to the user through an interface (e.g., comment composer, pop up) for selection by the user. The presentation of such information to the user in this manner enhances efficiency and user experience by allowing the user to quickly determine and specify relevant past recommendations. Many variations are possible.

In some embodiments, the recommendation generation module 256 can customize automatically suggested recommendations to provide based on a surface in which a recommendation request is accessed or viewed. For example, a surface can indicate any user interface or any portion of a user interface through which content of a social networking system can be provided. If the recommendation request is presented in a group, the recommendation generation module 256 can provide top recommended entities in the group as automatically suggested recommendations. If a recommendation request, such as a post, is in or to a group, automatically suggested recommendations for the post can be specifically selected from relevant recommendations that have been previously made in the group, if any. The specifically selected recommendations can be augmented with recommendations from other sources with priority given to the recommendations from the group. In some embodiments, a recommendation request can be provided by a user in a group (e.g., group chat, group page, etc.) to the group. Recommendations (e.g., comments) provided by members of the group in response to the recommendation request can be prioritized over recommendations provided by non-members. For example, in provision of prepopulated recommendations to the user, such as display of pins corresponding to the prepopulated recommendations through a map, recommendations provided by the members of the group can be prioritized over recommendations provided by non-members. If the recommendation request is presented in a feed of a viewing user, the recommendation generation module 256 can provide top recommended entities by one or more connections of the viewing user as automatically suggested recommendations. Many variations are possible.

The recommendation generation module 256 can provide automatically suggested recommendations in addition to any recommendations that are created directly in response to a recommendation request. For example, a user may create a post requesting recommendations, and other users may create comments as direct recommendations in response to the post. In some embodiments, the recommendation generation module 256 can provide automatically suggested recommendations before any direct recommendations are presented. In other embodiments, the recommendation generation module 256 can provide automatically suggested recommendations after a threshold number of direct recommendations is provided by users. Automatically suggested recommendations can supplement the direct recommendations from the other users. For example, one or more automatically suggested recommendations can be provided if a number of the direct recommendations does not satisfy a threshold value. If entities for recommendations are presented on a map, the recommendation generation module 256 can distinguish the appearance of indicators for locations of entities from direct recommendations from the appearance of indicators for locations of entities from automatically suggested recommendations. Direct recommendations may later be used as or to generate automatically suggested recommendations for recommendation requests by other users. In some embodiments, the recommendation generation module 256 can refine automatically suggested recommendations based on direct recommendations for a recommendation request. For example, one or more direct recommendations can be analyzed by natural language processing and machine learning techniques to more accurately determine a type of entity associated with the recommendation request. As an example, if the type of entity is determined to be a restaurant and entities in direct recommendations are determined to be a specific type of restaurant, automatically suggested recommendations that are consistent with the more specific type of restaurant can be selected or generated. Automatically suggested recommendations that are selected and presented in relation to a recommendation request, such as a post, can be refined based on recommendations that are added to the post via comments on the post. As an example, a post seeking restaurant recommendations in a specific city can be created. In this example, before anyone comments with any recommendations on the post, the most recommended restaurants can be automatically presented on the post. After someone provides a comment relating to a kind of restaurant on the post, automatic recommendations can be refined and presented based on the kind of restaurant recommended in the comment. For instance, if the kind of restaurant recommended is a Mexican restaurant, other recommended Mexican restaurants can be automatically selected and presented as a result of the comment. Many variations are possible.

One or more machine learning models, such as natural language processing models, discussed in connection with the recommendation module 102 and its components, such as the automated recommendation generation module 252, can be implemented separately or in combination, for example, as a single machine learning model, as multiple machine learning models, as one or more staged machine learning models, as one or more combined machine learning models, etc. All examples herein are provided for illustrative purposes, and there can be many variations and other possibilities.

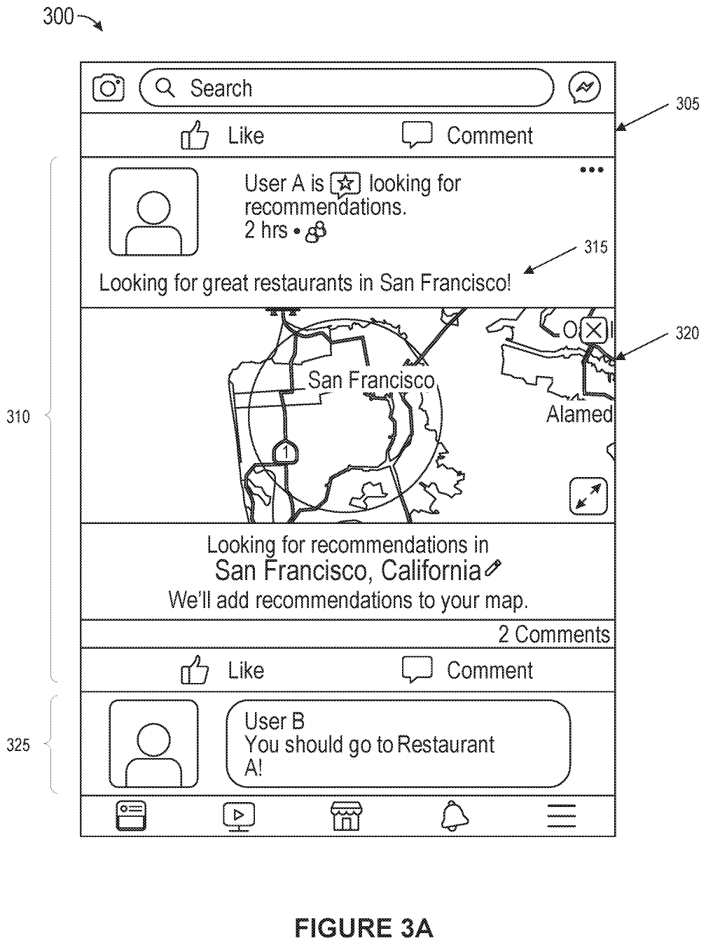

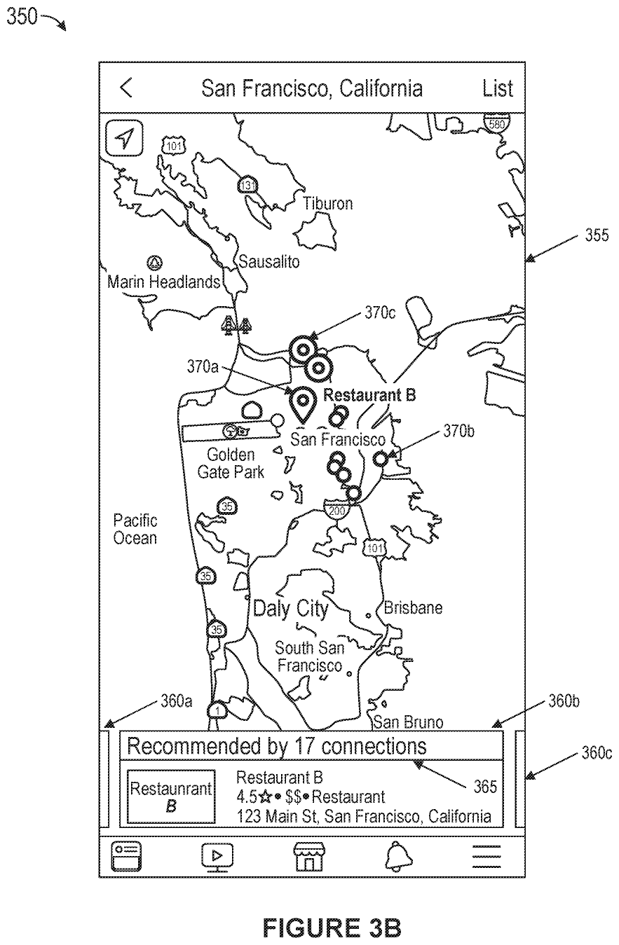

FIG. 3A illustrates an example user interface 300 for generating automated recommendations based on the recommendation module 102, according to an embodiment of the present technology. The user interface 300 shows a feed 305 of a viewing user. The feed 305 includes a post 310 that includes a recommendation request. The post 310 includes natural content language 315. The natural language content 315 can be analyzed by natural language processing techniques to determine whether the natural language content 315 includes a recommendation request. In the example of FIG. 3A, a type of entity associated with the recommendation request is restaurants, and a geographical area associated with the recommendation request is a city (e.g., San Francisco). The post 310 can include a map 320 for the geographical area. For example, when a user creates the post 310, a suggestion can be provided for a geographical area associated with the recommendation request, and the map 320 can be added to the post 310 after the user confirms the suggested geographical area. In the example of FIG. 3A, the recommendation request relates to locations or places. A user may create a comment 325 in response to the post 310 that includes a recommendation for the recommendation request. In the example of FIG. 3A, the comment 325 includes a recommendation for “Restaurant A.” In this example, the recommendation is a direct recommendation since the recommendation is provided in direct response to the recommendation request. Direct recommendations may be used as or to generate automatically suggested recommendations for subsequent recommendation requests. One or more automatically suggested recommendations for the recommendation request can be generated by the recommendation module 102, as discussed herein. All examples herein are provided for illustrative purposes, and there can be many variations and other possibilities.

FIG. 3B illustrates an example user interface 350 for generating automated recommendations based on the recommendation module 102, according to an embodiment of the present technology. The user interface 350 can be presented to a viewing user of the post 310 in the user interface 300 in FIG. 3A in response to selection of the map 320. For example, the user interface 350 can be a permanent link or permalink view of the map 320. The user interface 350 shows a map 355, which can be a detailed view of the map 320. One or more automatically suggested recommendations can be generated by the recommendation module 102, as discussed herein. In the example of FIG. 3B, an automatically suggested recommendation is represented as a card. The user interface 350 shows three cards 360a, 360b, 360c associated with automatically suggested recommendations, and the card 360b is shown as selected by the viewing user. The viewing user may navigate between the cards for automatically suggested recommendations, for example, by scrolling or swiping. In the example of FIG. 3B, the card 360b is generated based on previous recommendations by connections of the viewing user from an aggregated table. The card 360b can include a context row 365 that indicates a number of users (e.g., connections of the viewing user) who have recommended an entity associated with the corresponding automatically suggested recommendation. In some cases, a context row may identify one or more users (e.g., connections of the viewing user) who have recommended an entity associated with a corresponding automatically suggested recommendation. In other cases, a context row may indicate a source of recommendations from which a corresponding automatically suggested recommendation is generated. For example, sources of recommendations can include recommendations from connections of a viewing user, recommendations from users who are local to a geographical area associated with a recommendation request, recommendations for top recommended entities for a type of entity, etc. The card 360b can also include information about the entity that is recommended, such as a rating, a price range, a type of entity, an address, etc. The map 355 can show indicators corresponding to cards 360a, 360b, 360c. An indicator 370a is shown as a pin because the card 360b has been selected by the viewing user. Different types of indicators can be used to distinguish between automatically suggested recommendations and direct recommendations. For example, an indicator 370b can be used to represent an automatically suggested recommendation, and an indicator 370c can be used to represent a direct recommendation, such as a recommendation from the comment 325 in the user interface 300. All examples herein are provided for illustrative purposes, and there can be many variations and other possibilities.

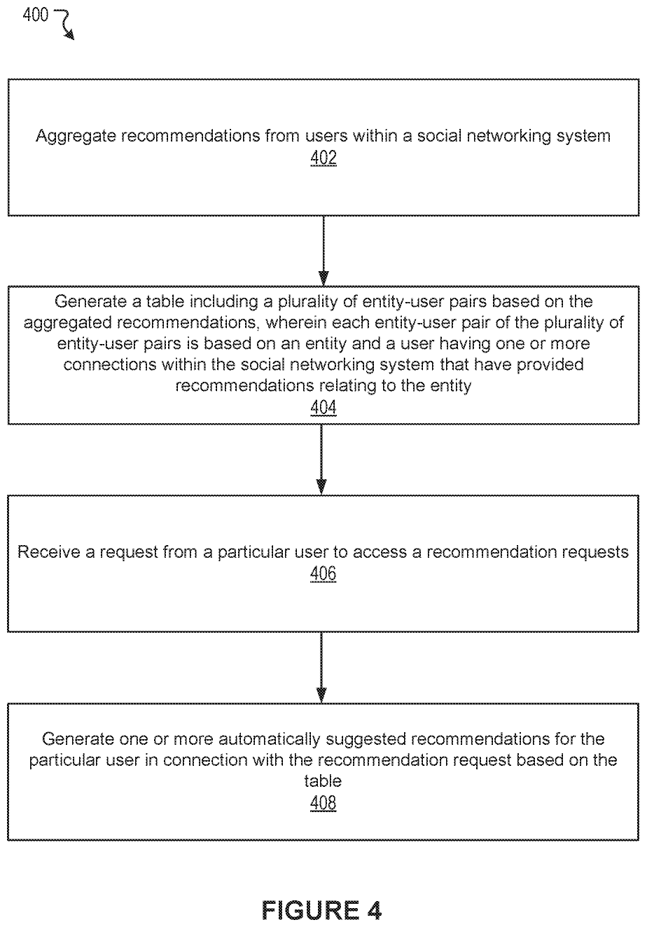

FIG. 4 illustrates an example first method 400 for generating automated recommendations, according to an embodiment of the present technology. It should be understood that there can be additional, fewer, or alternative steps performed in similar or alternative orders, or in parallel, based on the various features and embodiments discussed herein unless otherwise stated.

At block 402, the example method 400 can aggregate recommendations from users within a social networking system. At block 404, the example method 400 can generate a table including a plurality of entity-user pairs based on the aggregated recommendations, wherein each entity-user pair of the plurality of entity-user pairs is based on an entity and a user having one or more connections within the social networking system that have provided recommendations relating to the entity. At block 406, the example method 400 can receive a request from a particular user to access a recommendation request. At block 408, the example method 400 can generate one or more automatically suggested recommendations for the particular user in connection with the recommendation request based on the table. Other suitable techniques that incorporate various features and embodiments of the present technology are possible.

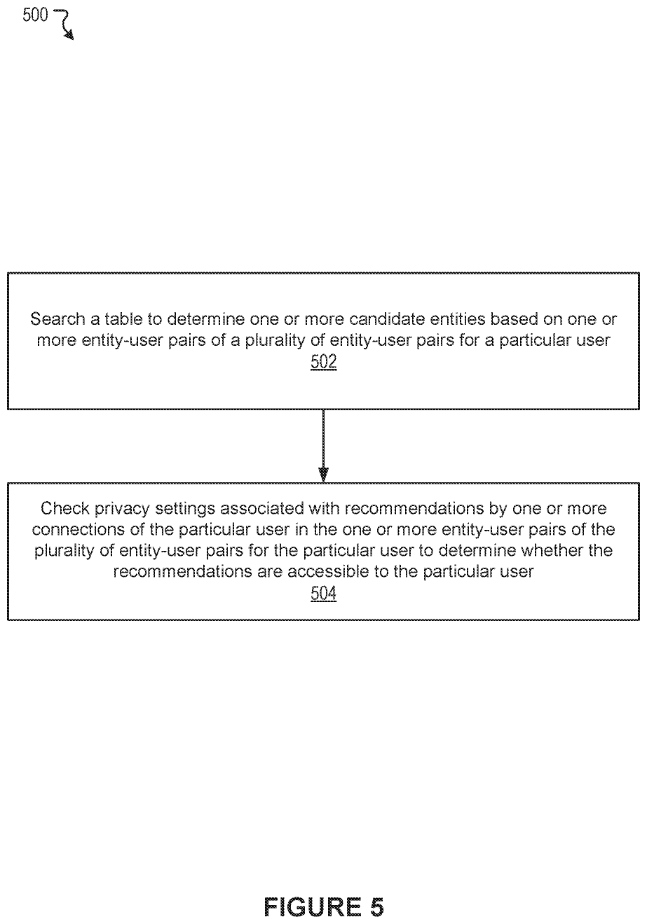

FIG. 5 illustrates an example second method 500 for generating automated recommendations, according to an embodiment of the present technology. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can search a table to determine one or more candidate entities based on one or more entity-user pairs of a plurality of entity-user pairs for a particular user. At block 504, the example method 500 can check privacy settings associated with recommendations by one or more connections of the particular user in the one or more entity-user pairs of the plurality of entity-user pairs for the particular user to determine whether the recommendations are accessible to the particular user. Other suitable techniques that incorporate various features and embodiments of the present technology are possible.

It is contemplated that there can be many other uses, applications, features, possibilities, and/or variations associated with various embodiments of the present technology. For example, users can, in some cases, choose whether or not to opt-in to utilize the present technology. The present technology can, for instance, also ensure that various privacy settings, preferences, and configurations are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a recommendation module 646. The recommendation module 646 can be implemented with the recommendation module 102, as discussed in more detail herein. In some embodiments, one or more functionalities of the recommendation module 646 can be implemented in the user device 610.

### Hardware Implementation

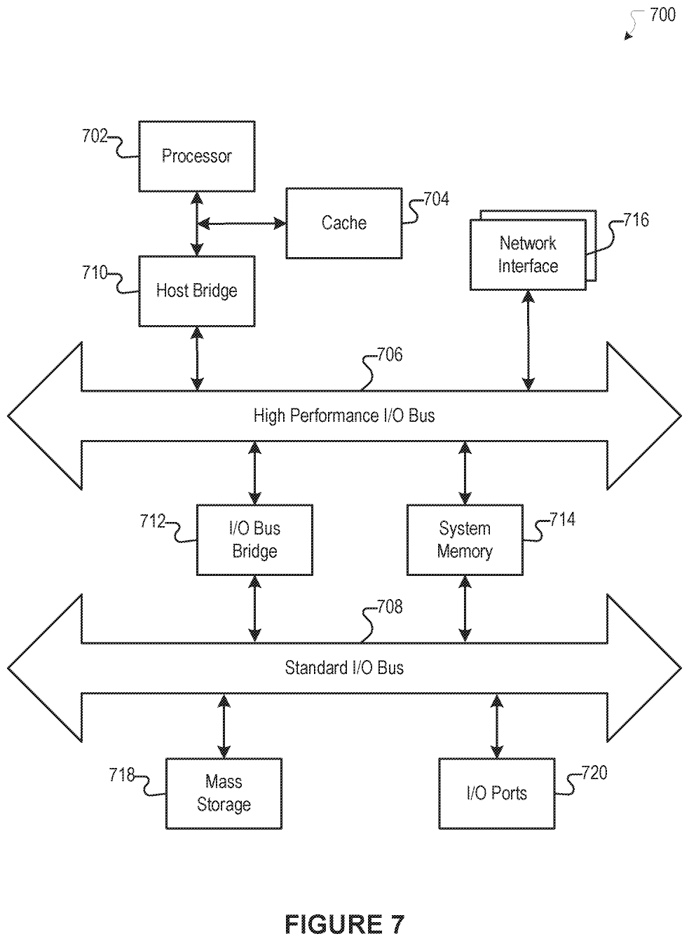

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, California, and the x86-compatible processors manufactured by Advanced Micro Devices (AMD), Inc., of Sunnyvale, California, as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
aggregating, by a computing system, recommendations from users within a system;
generating, by the computing system, a table including a plurality of entity-user pairs based on the aggregated recommendations, wherein each entity-user pair of the plurality of entity-user pairs is based on an entity and a user that has provided at least one of the aggregated recommendations, wherein the at least one of the aggregated recommendations relate to the entity;
receiving, by the computing system, a request from a first user to access a recommendation request;
generating, by the computing system, automatically suggested recommendations for the first user in connection with the recommendation request based on the table and one or more privacy settings associated with the aggregated recommendations, wherein the privacy settings allow access by the first user to at least one recommendation of the aggregated recommendations provided to an open group of which the first user is a non-member and at least one recommendation of the aggregated recommendations provided to a closed group of which the first user is a member;
ranking, by the computing system, the automatically suggested recommendations based on the first user, wherein the automatically suggested recommendations associated with connections of the first user are ranked higher than the automatically suggested recommendations associated with users who are local to a geographic area associated with the recommendation request;
providing, by the computing system, a card associated with a first automatically suggested recommendation of the automatically suggested recommendations, the first automatically suggested recommendation provided based on the ranking, wherein a first indicator corresponding with the card is highlighted;
providing, by the computing system, a map for display, the map prepopulated with the automatically suggested recommendations, wherein the automatically suggested recommendations are provided with a first type of indicator for automatically suggested recommendations;
receiving, by the computing system, a recommendation from a second user responsive to the recommendation request; and
updating, by the computing system, the map to further provide the recommendation from the second user responsive to the recommendation request, wherein the recommendation from the second user is provided with a second type of indicator for recommendations responsive to the recommendation request.

2. The computer-implemented method of claim 1, wherein the recommendation request specifies a type of entity and the geographical area for which a recommendation is requested.

3. The computer-implemented method of claim 1, wherein the privacy settings indicate a recommendation is accessible to at least one of a user who created the recommendation, connections of the user who created the recommendation, connections of connections of the user who created the recommendation, or all users.

4. The computer-implemented method of claim 1, wherein the table is generated offline.

5. The computer-implemented method of claim 1, wherein the generating the automatically suggested recommendations includes searching the table to determine one or more candidate entities based on one or more entity-user pairs of the plurality of entity-user pairs for the first user.

6. The computer-implemented method of claim 5, wherein the generating the automatically suggested recommendations includes checking the privacy settings associated with recommendations by the connections of the first user in the one or more entity-user pairs of the plurality of entity-user pairs for the first user to determine whether the recommendations are accessible to the first user.

7. The computer-implemented method of claim 5, wherein the automatically suggested recommendations includes a predetermined number of the one or more candidate entities.

8. The computer-implemented method of claim 1, wherein the automatically suggested recommendations associated with users who are local to the geographical area associated with the recommendation request are ranked higher than the automatically suggested recommendations associated with top candidate entities of a type of entity associated with the recommendation request.

9. The computer-implemented method of claim 1, further comprising determining that natural language content includes the recommendation request based on natural language processing.

10. The computer-implemented method of claim 1, wherein the recommendation request is generated in a feed of the first user, a group in the system, or a page in the system.

11. A computing system comprising:
at least one hardware processor; and
a memory storing instructions that, when executed by the at least one processor, cause the computing system to perform:
aggregating recommendations from users within a system;
generating a table including a plurality of entity-user pairs based on the set of aggregated recommendations, wherein each entity-user pair of the plurality of entity-user pairs is based on an entity and a user that has provided at least one of the aggregated recommendations, wherein the at least one of the aggregated recommendations relate to the entity;
receiving a request from a first user to access a recommendation request;
generating automatically suggested recommendations for the first user in connection with the recommendation request based on the table and one or more privacy settings associated with the aggregated recommendations, wherein the privacy settings allow access by the first user to at least one recommendation of the aggregated recommendations provided to an open group of which the first user is a non-member and at least one recommendation of the aggregated recommendations provided to a closed group of which the first user is a member;
ranking the automatically suggested recommendations based on the first user, wherein the automatically suggested recommendations associated with connections of the first user are ranked higher than the automatically suggested recommendations associated with users who are local to a geographic area associated with the recommendation request;
providing a card associated with a first automatically suggested recommendation of the automatically suggested recommendations, the first automatically suggested recommendation provided based on the ranking, wherein a first indicator corresponding with the card is highlighted;
providing a map for display, the map prepopulated with the automatically suggested recommendations, wherein the automatically suggested recommendations are provided with a first type of indicator for automatically suggested recommendations;
receiving a recommendation from a second user responsive to the recommendation request; and
updating the map to further provide the recommendation from the second user responsive to the recommendation request, wherein the recommendation from the second user is provided with a second type of indicator for recommendations responsive to the recommendation request.

12. The computing system of claim 11, wherein the instructions further cause the system to perform obtaining a response to the recommendation request including natural language content.

13. The computing system of claim 11, wherein the instructions further cause the system to perform determining that the recommendation from the second user is responsive to the recommendation request based on natural language processing.

14. The computing system of claim 13, wherein the instructions further cause the system to perform determining a type of entity associated with the recommendation from the second user.

15. The computing system of claim 14, wherein the instructions further cause the system to perform updating the automatically suggested recommendations based on the type of entity associated with the recommendation from the second user.

16. A non-transitory computer readable medium including instructions that, when executed by at least one hardware processor of a computing system, cause the computing system to perform:
aggregating recommendations from users within a system;
generating a table including a plurality of entity-user pairs based on the aggregated recommendations, wherein each entity-user pair of the plurality of entity-user pairs is based on an entity and a user that has provided at least one of the aggregated recommendations, wherein the at least one of the aggregated recommendations relate to the entity;
receiving a request from a first user to access a recommendation request;
generating automatically suggested recommendations for the first user in connection with the recommendation request based on the table and one or more privacy settings associated with the aggregated recommendations, wherein the privacy settings allow access by the first user to at least one recommendation of the aggregated recommendations provided to an open group of which the first user is a non-member and at least one recommendation of the aggregated recommendations provided to a closed group of which the first user is a member;
ranking the automatically suggested recommendations based on the first user, wherein the automatically suggested recommendations associated with connections of the first user are ranked higher than the automatically suggested recommendations associated with users who are local to a geographic area associated with the recommendation request;
providing a card associated with a first automatically suggested recommendation of the automatically suggested recommendations, the first automatically suggested recommendation provided based on the ranking, wherein a first indicator corresponding with the card is highlighted;
providing a map for display, the map prepopulated with the automatically suggested recommendations, wherein the automatically suggested recommendations are provided with a first type of indicator for automatically suggested recommendations;
receiving a recommendation from a second user responsive to the recommendation request; and
updating the map to further provide the recommendation from the second user responsive to the recommendation request, wherein the recommendation from the second user is provided with a second type of indicator for recommendations responsive to the recommendation request.

17. The non-transitory computer readable medium of claim 16, wherein the request from the first user to access the recommendation request is generated in a feed of the first user, a group in the system, or a page in the system.

18. The non-transitory computer readable medium of claim 16, wherein the instructions further cause the computing system to perform obtaining one or more direct recommendations for the recommendation request.

19. The non-transitory computer readable medium of claim 18, wherein the automatically suggested recommendations are generated after a threshold number of direct recommendations is obtained.

20. The non-transitory computer readable medium of claim 16, wherein the map and the automatically suggested recommendations are presented in a user interface.
